(19) United States
(12) Patent Application Publication
(10) Pub. No.: US 2024/0055882 A1
(43) Pub. Date: Feb. 15, 2024

(54) STORAGE BATTERY CONTROL DEVICE AND STORAGE BATTERY CONTROL METHOD

(71) Applicants: KABUSHIKI KAISHA TOSHIBA, Tokyo (JP); TOSHIBA ENERGY SYSTEMS & SOLUTIONS CORPORATION, Kawasaki-shi Kanagawa (JP)

(72) Inventors: Masako KIUCHI, Fuchu Tokyo (JP); Mami MIZUTANI, Hachioji Tokyo (US); Takahiro KASE, Kawasaki Kanagawa (JP); Takenori KOBAYASHI, Meguro Tokyo (JP); Makoto IDE, Koganei Tokyo (JP); Yukitaka MONDEN, Kawasaki Kanagawa (JP); Kenji MITSUMOTO, Setagaya Tokyo (JP); Yoshihisa SUMIDA, Nakano Tokyo (JP)

(73) Assignees: KABUSHIKI KAISHA TOSHIBA, Tokyo (JP); TOSHIBA ENERGY SYSTEMS & SOLUTIONS CORPORATION, Kawasaki-shi Kanagawa (JP)

(21) Appl. No.: 18/260,610

(22) PCT Filed: Jan. 7, 2021
(86) PCT No.: PCT/JP2021/000356

§ 371 Date: Jul. 6, 2023

(51) Int. Cl. H02J 7/00; H02J 7/06

(52) U.S. Cl. CPC H02J 7/00712; H02J 7/06; H02J 7/0048; H02J 7/005

(57) ABSTRACT

A storage battery control device includes a hardware processor functioning as an acquisition unit, a first calculation unit, and a control part. The acquisition unit acquires operation conditions of a storage battery system including a storage battery being chargeable and dischargeable. The first calculation unit calculates, as a first predicted value, a battery capacity of the storage battery in a predetermined period on the basis of the operation conditions acquired by the acquisition unit. The battery capacity corresponds to a case where the storage battery is operated under the operation conditions. The control part controls a charging voltage when the storage battery system charges the storage battery. The charging voltage is controlled on the basis of the first predicted value calculated by the first calculation unit.

### CROSS-REFERENCE TO RELATED APPLICATIONS

This application is national stage application of International Application No. PCT/JP2021/00356, filed on Jan. 7, 2021, which designates the United States, incorporated herein by reference.

### FIELD

Embodiments described herein relate generally to a storage battery control device and a storage battery control method.

### BACKGROUND

Conventionally, storage battery systems have been used for various purposes. For example, while power supplied from a commercial power supply or the like is usually stored in a storage battery, power may be supplied from the storage battery in case of a power failure of the commercial power supply or the like in order to stably supply the power. In the storage battery system having such a form, when the storage battery becomes fully charged, the charging mode may be switched to a constant voltage charging mode such as a float charging mode, thereby maintaining power.

By the way, in the constant voltage charging mode described above, the voltage applied to the storage battery is maintained in a high voltage state, so that there is a problem that the storage battery easily deteriorates. The degree of progress of deterioration of the storage battery also varies depending on the temperature condition of the use environment.

Conventionally, there has been proposed a technique of controlling a charging voltage by predicting a deterioration of a storage battery at an optional time point by using an actual deterioration rate of the storage battery at a current time point obtained by measurement and a deterioration master curve indicating a deteriorating tendency of the storage battery prepared for each condition such as temperature.

### BRIEF DESCRIPTION OF DRAWINGS

FIG. 1 is a diagram illustrating an example of a configuration of a storage battery control system according to a first embodiment.

FIG. 2 is a diagram illustrating an example of a configuration of a storage battery system according to the first embodiment.

FIG. 3 is a diagram for explaining detailed configurations of a cell module, a CMU, and a BMU according to the first embodiment.

FIG. 4 is a diagram illustrating an example of a hardware configuration of a storage battery control part according to the first embodiment.

FIG. 5 is a block diagram illustrating an example of a functional configuration of the storage battery control part according to the first embodiment.

FIG. 6 is a diagram schematically illustrating an example of a calculation result of a battery capacity calculation unit according to the first embodiment.

FIG. 7 is a flowchart illustrating an example of processing executed by the storage battery control part according to the first embodiment.

FIG. 8 is a diagram schematically illustrating an example of a configuration of a storage battery control system according to a first modification of the first embodiment.

FIG. 9 is a diagram schematically illustrating an example of a configuration of a storage battery control system according to a third modification of the first embodiment.

FIG. 10 is a diagram illustrating an example of a functional configuration of a storage battery control part according to a second embodiment.

FIG. 11 is a diagram schematically illustrating an example of a calculation result of a battery capacity calculation unit according to the second embodiment.

FIG. 12 is a flowchart illustrating an example of processing executed by the storage battery control part according to the second embodiment.

FIG. 13 is a diagram illustrating an example of a functional configuration of a storage battery control part according to the third embodiment.

FIG. 14 is a diagram schematically illustrating an example of calculation results of a battery capacity calculation unit and an output capacity calculation unit according to the third embodiment.

FIG. 15 is a flowchart illustrating an example of processing executed by the storage battery control part according to the third embodiment.

FIG. 16 is a diagram illustrating an example of a functional configuration of a storage battery control part according to a fourth embodiment.

FIG. 17 is a diagram schematically illustrating an example of calculation results of a battery capacity calculation unit and an output capacity calculation unit according to the fourth embodiment.

FIG. 18 is a flowchart illustrating an example of processing executed by the storage battery control part according to the fourth embodiment.

FIG. 19 is a diagram illustrating an example of a functional configuration of a storage battery control part according to a fifth embodiment.

FIG. 20 is a flowchart illustrating an example of processing executed by the storage battery control part according to the fifth embodiment.

FIG. 21 is a diagram illustrating an example of a functional configuration of a storage battery control part according to a sixth embodiment.

FIG. 22 is a flowchart illustrating an example of processing executed by the storage battery control part according to the sixth embodiment.

### DETAILED DESCRIPTION

A storage battery control device according to one embodiment includes a hardware processor connected to a memory. The hardware processor is configured to function as an acquisition unit, a first calculation unit, and a control part. The acquisition unit acquires operation conditions of a storage battery system including a storage battery being chargeable and dischargeable. The first calculation unit calculates, as a first predicted value, a battery capacity of the storage battery in a predetermined period on the basis of the operation conditions acquired by the acquisition unit. The battery capacity corresponds to a case where the storage battery is operated under the operation conditions. The control part controls a charging voltage when the storage battery system charges the storage battery. The charging voltage is controlled on the basis of the first predicted value calculated by the first calculation unit.

Hereinafter, embodiments of the present invention will be described with reference to the drawings. The configurations of the embodiments described below and the actions and results (effects) caused thereby are merely examples, and are not limited only to the following description.

### First Embodiment

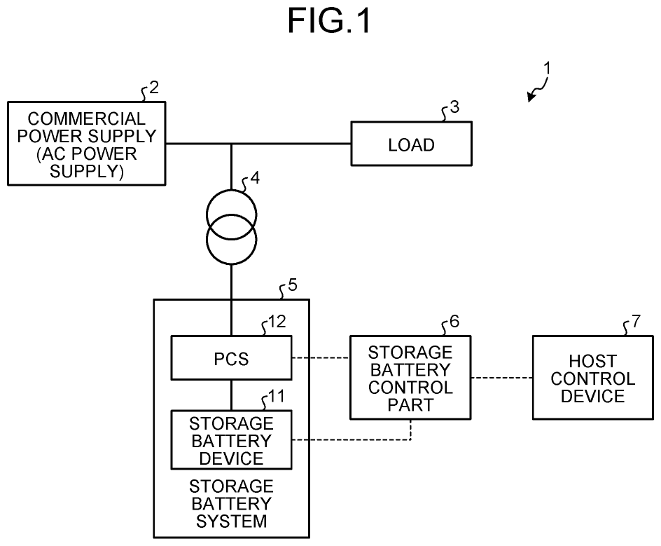

FIG. 1 is a diagram illustrating an example of a configuration of a storage battery control system 1 according to a first embodiment. The storage battery control system 1 includes a commercial power supply 2, a load 3, a transformer 4, a storage battery system 5, a storage battery control part 6, and a host control device 7.

The commercial power supply 2 is an AC power supply, and supplies power (AC power) to the storage battery system 5 via the transformer 4. The load 3 is a device that consumes power. The load 3 usually operates by being supplied with power from the commercial power supply 2, but when the power supply from the commercial power supply 2 is stopped, the load 3 operates by being supplied with power from the storage battery system 5.

The storage battery system 5 charges the commercial power supply 2 with power or supplies power to the load 3. Specifically, the storage battery system 5 includes a storage battery device 11 and a power conditioning system (PCS) 12.

The storage battery device 11 is an example of a storage battery being chargeable and dischargeable. The storage battery device 11 performs charging/discharging operation in cooperation with the PCS 12. The PCS 12 converts DC power supplied from the storage battery device 11 into AC power having a desired power quality and supplies the AC power to the load 3. Also, the PCS 12 converts AC power supplied from the commercial power supply 2 into DC power having a desired power quality, and supplies the DC power to the storage battery device 11.

The storage battery control part 6 is an example of a storage battery control device. The storage battery control part 6 controls the storage battery system 5 via the PCS 12. For example, when charging power can be supplied from the commercial power supply 2 to the storage battery device 11, the storage battery control part 6 switches the storage battery device 11 to a charging state to charge the storage battery device 11. When the storage battery device 11 becomes fully charged, the storage battery control part 6 switches the storage battery device 11 to a constant voltage charging mode such as a float charging mode.

In the constant voltage charging mode, in a situation where the storage battery device 11 reaches a predetermined voltage and its voltage fluctuates within a given range, the current of the charging power does not substantially flow to the storage battery device 11, and the storage battery device 11 is maintained in a state where only the voltage of the charging power is applied thereto. In the constant voltage charging mode, since the voltage applied to the storage battery device 11 is maintained in a high voltage state, there is a problem that the storage battery easily deteriorates. Hereinafter, the voltage applied to the storage battery device 11 in the constant voltage charging mode will be referred to as a “charging voltage”.

When the power supply from the commercial power supply 2 is stopped, the storage battery control part 6 switches the storage battery device 11 to a discharging state to supply power to the load 3. The host control device 7 remotely controls the storage battery control part 6.

Although it has been described above that the storage battery system 5 is operated as a backup power supply, the present invention is similarly applicable in a case where power is supplied from the storage battery system 5 in addition to supplied from the commercial power supply 2 at the time of peak shift for power load leveling. The present invention can also be applied to stabilize power quality (voltage, frequency, etc.) in a case where power is generated by renewable energy (energy by sunlight, solar heat, hydraulic power, wind power, biomass, geothermal heat, etc.).

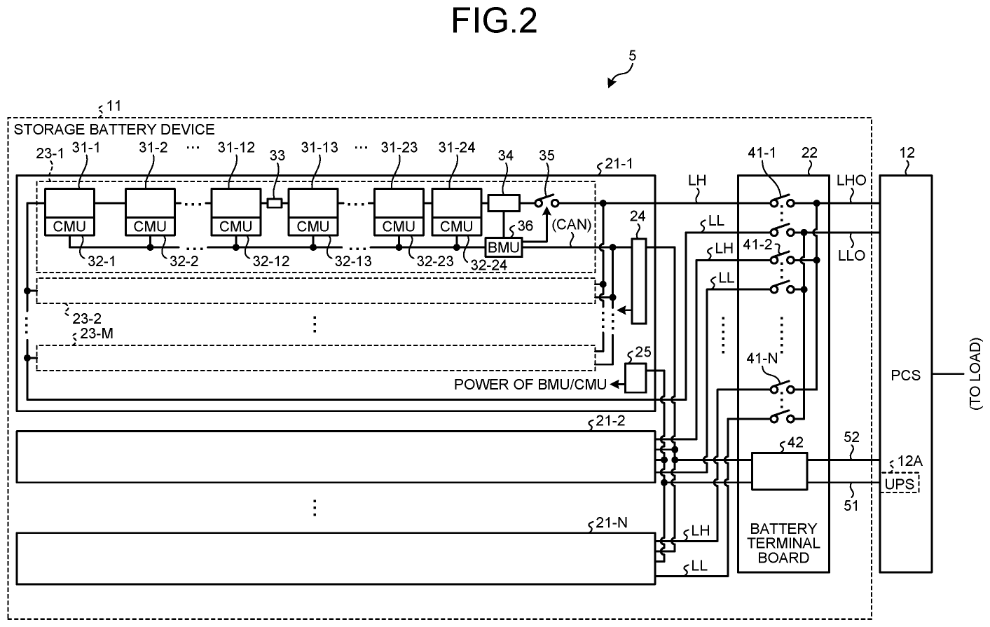

FIG. 2 is a diagram illustrating an example of a configuration of the storage battery system 5. The storage battery system 5 includes a storage battery device 11 as described above and a PCS 12.

The storage battery device 11 mainly includes a plurality of battery boards 21-1 to 21-N (N is a natural number), and a battery terminal board 22 to which the battery boards 21-1 to 21-N are connected. Each of the battery boards 21-1 to 21-N includes a plurality of battery units 23-1 to 23-M (M is a natural number) connected in parallel to each other, a gateway device 24, and a DC power supply device 25 that supplies DC power for operation to a battery management unit (BMU) and a cell monitoring unit (CMU) to be described later.

The battery units 23-1 to 23-M are each connected to output power supply lines (output power supply lines; bus) LHO and LLO via a high potential-side power supply line (high potential-side power supply line) LH and a low potential-side power supply line (low potential-side power supply line) LL in order to supply power to the PCS 12 that is a main circuit.

The battery units 23-1 to 23-M have the same configuration, and the battery unit 23-1 will be described as an example. The battery unit 23-1 mainly includes a plurality of cell modules 31-1 to 31-24 (in FIG. 2, the number of cell modules is twenty-four), a plurality of CMUs 32-1 to 32-24 (in FIG. 2, the number of CMUs is twenty-four) provided in the cell modules 31-1 to 31-24, respectively, a service disconnect 33 provided between the cell module 31-12 and the cell module 31-13, a current sensor 34, and a contactor 35. The cell modules 31-1 to 31-24, the service disconnect 33, the current sensor 34, and the contactor 35, are connected in series.

Each of the cell modules 31-1 to 31-24 constitutes a battery pack by connecting battery cells in series and in parallel. The cell modules 31-1 to 31-24 connected in series constitute a battery pack group.

The battery unit 23-1 includes a BMU 36, and a communication line of each of the CMUs 32-1 to 32-24 and an output line of the current sensor 34 are connected to the BMU 36. The BMU 36 controls the entire battery unit 23-1 under the control of the gateway device 24, and controls whether to open or close the contactor 35 on the basis of a result of communication with each of the CMUs 32-1 to 32-24 (voltage data and temperature data to be described later) and a detection result of the current sensor 34.

Next, a configuration of the battery terminal board will be described. The battery terminal board 22 includes board breakers 41-1 to 41-N provided correspondingly to the battery boards 21-1 to 21-N, and a master device 42 configured as a microcomputer that controls the entire storage battery device 11.

The master device 42 is connected to the PCS 12 via a control power line 51 and a control communication line 52. The control power line 51 is provided via an uninterruptible power system (UPS) 12A of the PCS 12. The control communication line 52 is configured as Ethernet (registered trademark) to exchange control data.

Here, detailed configurations of the cell modules 31-1 to 31-24, the CMUs 32-1 to 32-24, and the BMU 36 will be described.

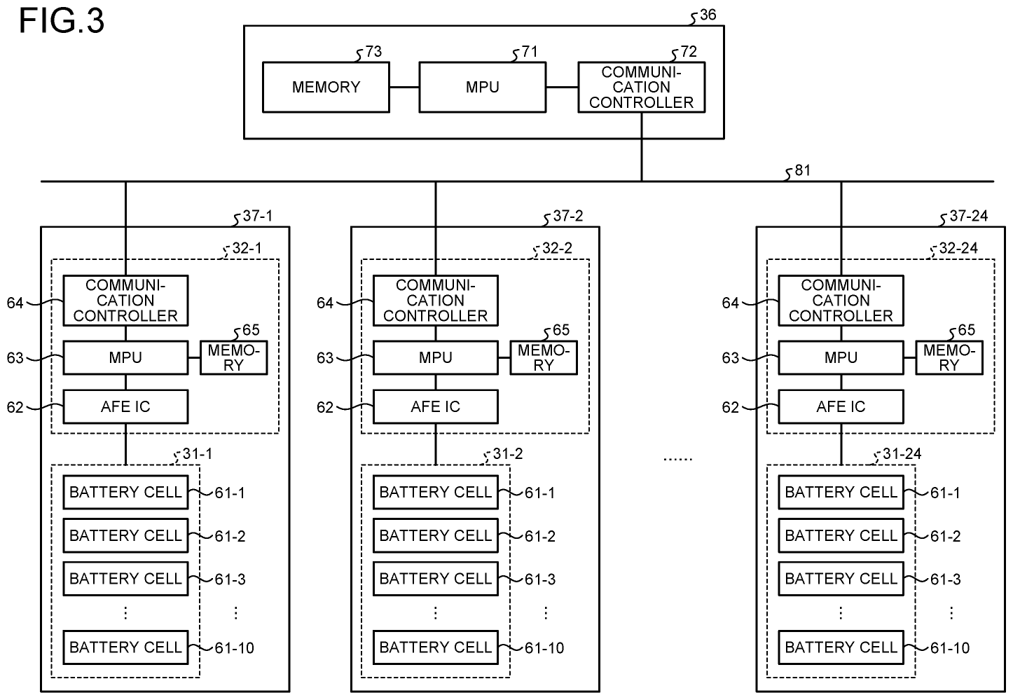

FIG. 3 is a diagram for explaining detailed configurations of the cell modules, the CMUs, and the BMU. Each of the cell modules 31-1 to 31-24 includes a plurality of battery cells 61-1 to 61-10 (in FIG. 3, the number of battery cells is ten) connected in series.

Each of the CMUs 32-1 to 32-24 includes a voltage and temperature measuring IC (analog front end IC (AFE-IC)) 62 for measuring voltages of the battery cells 61-1 to 61-10 constituting a corresponding one of the cell modules 31-1 to 31-24 and temperatures at predetermined positions, an MPU 63 that controls an entire corresponding one of the CMUs 32-1 to 32-24, a communication controller 64 that conforms to a controller area network (CAN) standard for performing communications with the BMU 36 via a CAN 81, and a memory 65 that stores voltage data corresponding to the voltages of the respective cells and temperature data.

In addition, the BMU 36 includes an MPU 71 that controls the entire BMU 36, a communication controller 72 that conforms to a CAN standard for performing CAN communication with the CMUs 32-1 to 32-24, and a memory 73 that stores voltage data and temperature data transmitted from the CMUs 32-1 to 32-24.

In the following description, a combination of each of the cell modules 31-1 to 31-24 and a corresponding one of the CMUs 32-1 to 32-24 will be referred to as a “battery module” (37-1 to 37-24). Each of the battery cells 61-1 to 61-10 will be referred to as a “battery cell”. Moreover, each of the battery units 23-1 to 23-M is referred to as a “battery unit”.

Each of the battery unit, the battery module, and the battery cell is an example of the storage battery. The storage battery control part 6 controls the charging voltage of any one of the storage battery device 11, the battery unit, the battery module, and the battery cell as a storage battery control unit. Hereinafter, any control unit among the storage battery device 11, the battery unit, the battery module, and the battery cell will also be simply referred to as a “storage battery”.

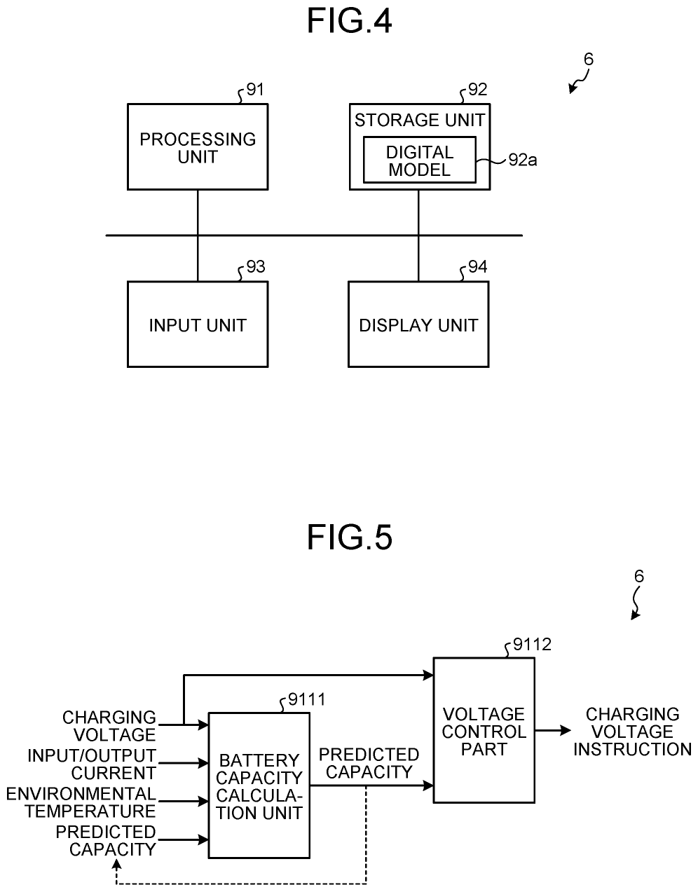

FIG. 4 is a diagram illustrating an example of a hardware configuration of the storage battery control part 6. As illustrated in FIG. 4, the storage battery control part 6 includes a processing unit 91, a storage unit 92, an input unit 93, and a display unit 94. Note that the storage battery control part 6 also includes a communication interface for communicating with other devices, but illustration and description thereof are omitted in order to simplify the description.

The processing unit 91 is a processor such as a central processing unit (CPU), and controls the overall processing of the storage battery control part 6.

The storage unit 92 is a storage device such as a read only memory (ROM), a random access memory (RAM), a hard disk drive (HDD), or a solid state drive (SSD). The storage unit 92 stores various programs and setting information related to the operation of the storage battery control part 6.

In addition, the storage unit 92 stores a digital model 92a that functions to output a state of health (SOH) or a battery capacity (hereinafter, collectively referred to as a battery capacity) of the storage battery in an optional period (at an optional time point) as a predicted value by inputting an operation condition or the like of the storage battery system 5 (storage battery device 11).

The digital model 92a is data capable of reproducing the operation and deterioration characteristics of the storage battery in a simulative manner, and is implemented by, for example, a simulator program or the like. By reproducing the operation and deterioration characteristics of the storage battery in a simulative manner on the basis of the input operation condition, the digital model 92a outputs a battery capacity of the storage battery in the predetermined period as a predicted value that corresponds to a case where the storage battery is operated under the operation condition. More specifically, the digital model 92a derives, as the predicted value, a tendency of the battery capacity of the storage battery that decreases (deteriorates) with the lapse of time. That is, the predicted value output from the digital model 92a represents the deterioration state of the storage battery or the lifespan of the storage battery.

Note that the digital model 92a according to the present embodiment functions to output, as a predicted value, a battery capacity in an optional period on the basis of a charging voltage when the storage battery is charged at a constant voltage. The operation condition input to the digital model 92a includes at least a charging voltage. In addition, the operation condition may include other information for deriving a deterioration state of the storage battery. For example, the operation condition may include an input/output current when the storage battery performs charging/discharging operation. The operation condition may also include a temperature around the storage battery or a temperature of the storage battery itself (hereinafter, also collectively referred to as environmental temperature). In addition, in the digital model 92a, for example, the battery capacity of the storage battery device 11 at a predetermined time point, such as at the time of factory shipment, may be set as an initial condition.

The input unit 93 receives various input operations from an operator, converts the received input operations into electric signals, and outputs the electric signals to the processing unit 91. The input unit 93 is implemented by, for example, a keyboard, a mouse, or the like.

The display unit 94 displays various types of information and screens under the control of the processing unit 91. The display unit 94 is implemented by, for example, a liquid crystal display or a cathode ray tube (CRT) display.

FIG. 5 is a block diagram illustrating an example of a functional configuration of the storage battery control part 6. As illustrated in FIG. 5, the storage battery control part 6 includes a battery capacity calculation unit 9111 and a voltage control part 9112 as functional units.

Part of or all the functional units included in the storage battery control part 6 may have a software configuration implemented by the processing unit 91 executing a program stored in the storage unit 92. In addition, part of or all the functional units included in the storage battery control part 6 may have a hardware configuration implemented by a dedicated circuit included in the processing unit 91 or the like.

The battery capacity calculation unit 9111 is an example of an acquisition unit and a first calculation unit. The battery capacity calculation unit 9111 calculates a battery capacity of the storage battery in a predetermined period as a predicted value in cooperation with the digital model 92a.

Specifically, the battery capacity calculation unit 9111 acquires a charging voltage, an input/output current, an environmental temperature, and so forth of the storage battery as operation conditions of the storage battery system 5, and inputs the acquired operation conditions to the digital model 92a.

It is not particularly limited as to where the operation conditions are acquired from, and the operation conditions may be acquired in various forms. For example, the battery capacity calculation unit 9111 may acquire the operation condition stored in advance in the storage unit 92 or the like. In addition, for example, the battery capacity calculation unit 9111 may acquire the operation condition from the storage battery system 5 or the PCS 12. In addition, the battery capacity calculation unit 9111 may acquire the operation condition input via the input unit 93.

In addition, the battery capacity calculation unit 9111 acquires a predicted value output by the digital model 92a as a predicted capacity by inputting the operation conditions to the digital model 92a. Specifically, the battery capacity calculation unit 9111 calculates, as a predicted capacity (first predicted value), a battery capacity of the storage battery in a predetermined period, which corresponds to a case where the storage battery is operated under the acquired operation conditions.

Note that the battery capacity calculation unit 9111 may recursively input the battery capacity calculated by itself as indicated by a broken line in FIG. 5. In this case, the battery capacity set as an initial condition is sequentially updated.

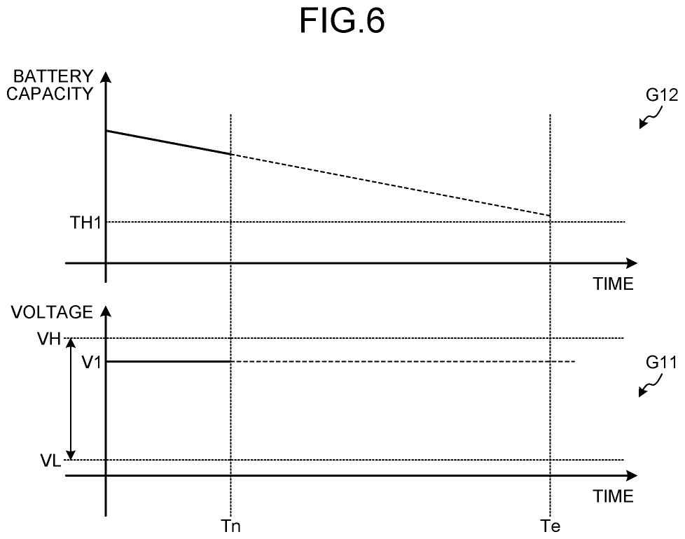

FIG. 6 is a diagram schematically illustrating an example of a calculation result of the battery capacity calculation unit 9111. Here, FIG. 6 is a diagram illustrating a relationship between a charging voltage and a battery capacity of the storage battery, and is represented by, for example, a graph G11 and a graph G12.

The graph G11 shows how the charging voltage of the storage battery goes, where the vertical axis represents voltage (charging voltage) and the horizontal axis represents time. The range of voltages VL to VH is a voltage range in which the storage battery can be safely charged at a constant voltage. In addition, time Te is a target date (hereinafter, also referred to as a device-sustainable year) up to which the storage battery is to be continuously used.

On the other hand, the graph G12 shows how the battery capacity of the storage battery goes, where the vertical axis represents battery capacity of the storage battery and the horizontal axis represents time. Threshold value TH1 is an example of a first threshold value, and is a battery capacity at which the lifespan of the storage battery is considered to be exhausted. Note that the time axes (horizontal axes) of the graph G11 and the graph G12 are synchronized.

In FIG. 6, the storage battery is charged with the constant voltage of a charging voltage V1 until a time Tn as a current time point. The charging voltage V1 and a predicted capacity, each corresponding to a case where the constant voltage charging will be continued at the same charging voltage in the future, are indicated by broken lines.

As described above, the battery capacity of the storage battery decreases (deteriorates) with the lapse of time in accordance with the operation condition (charging voltage) of the charging voltage V1. As shown in the graph G12, the predicted capacity calculated by the battery capacity calculation unit 9111 is obtained by predicting a tendency toward which the battery capacity deteriorates, and a predicted capacity at an optional time point can be specified from the tendency toward which the battery capacity deteriorates. It is possible to determine whether the predicted capacity during a period from the time Tn to the time Te is equal to or greater than the threshold value TH1, or determine whether the predicted capacity at the time Te is equal to or greater than the threshold value TH1.

Returning to FIG. 5, the voltage control part 9112 will be described. The voltage control part 9112 is an example of a control part. The voltage control part 9112 controls the charging voltage applied to the storage battery by the PCS 12 on the basis of the calculation result of the battery capacity calculation unit 9111.

Specifically, the voltage control part 9112 controls the charging voltage when the PCS 12 charges the storage battery at the constant voltage, by transmitting an amount of change in current charging voltage acquired by the battery capacity calculation unit 9111 to the PCS 12 as a charging voltage instruction on the basis of the predicted capacity calculated by the battery capacity calculation unit 9111.

Note that a method of controlling the charging voltage is not particularly limited, and various forms can be adopted. For example, the voltage control part 9112 determines whether the predicted capacity of the storage battery from the time Tn to the time Te is equal to or greater than the threshold value TH1, or determines whether the predicted capacity of the storage battery at the time Te is equal to or greater than the threshold value TH1 on the basis of the calculation result of the battery capacity calculation unit 9111. Then, when the predicted capacity is equal to or greater than the threshold value TH1, the voltage control part 9112 executes control for maintaining the current charging voltage.

In addition, when the predicted capacity is smaller than the threshold value TH1, the voltage control part 9112 executes control for changing the current charging voltage. For example, when the predicted capacity is smaller than the threshold value TH1, the voltage control part 9112 instructs a new charging voltage obtained by decreasing the current charging voltage by a predetermined amount to the PCS 12. Note that the voltage control part 9112 changes the charging voltage in the above-described range of voltages VL to VH.

In response to receiving a charging voltage instruction from the voltage control part 9112, the PCS 12 executes constant voltage charging of the storage battery at the instructed charging voltage. That is, the charging voltage of the storage battery is changed under the control of the voltage control part 9112.

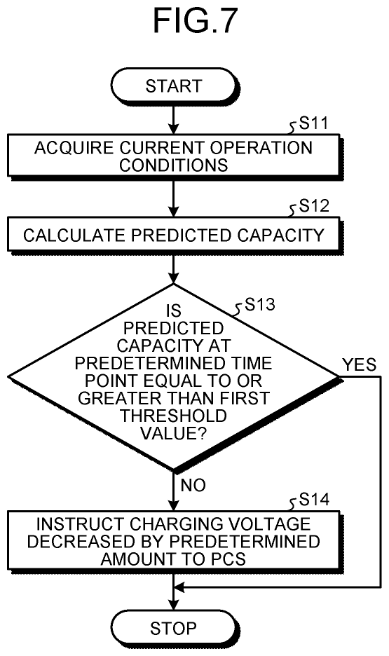

Hereinafter, the operation of the storage battery control part 6 will be described with reference to FIG. 7. FIG. 7 is a flowchart illustrating an example of processing executed by the storage battery control part 6. Note that the timing at which this processing is executed is not particularly limited, but the present embodiment will be described assuming that this processing is performed at the time of constant voltage charging.

First, the battery capacity calculation unit 9111 acquires current operation conditions of the storage battery (step S11). Next, the battery capacity calculation unit 9111 calculates a predicted capacity of the storage battery in a predetermined period that is future from the present, on the basis of the operation conditions acquired in step S11 (step S12).

On the basis of the calculation result of step S12, the voltage control part 9112 determines whether the predicted capacity at a predetermined time point, such as a device-sustainable year, is equal to or greater than a first threshold value (step S13). In response to determining that the predicted capacity is equal to or greater than the first threshold value (step S13; Yes), the voltage control part 9112 ends this processing while maintaining the current charging voltage.

On the other hand, in response to determining in step S13 that the predicted capacity is smaller than the first threshold value (step S13; No), the voltage control part 9112 instructs a new charging voltage obtained by decreasing the current charging voltage by a predetermined amount to the PCS 12 (step S14), and ends this processing.

As described above, the storage battery control part 6 acquires operation conditions of the storage battery system 5. The storage battery control part 6 calculates, as a predicted capacity, a battery capacity of the storage battery in a predetermined period, which corresponds to a case where the storage battery is operated under the operation conditions, on the basis of the acquired operation conditions. Then, the storage battery control part 6 controls a charging voltage when the storage battery is charged at a constant voltage on the basis of the predicted capacity.

With this configuration, for example, when the storage battery cannot be used up to the device-sustainable year in a state where the predicted capacity is maintained as being equal to or greater than the first threshold value under the current operation conditions of the storage battery, the storage battery control part 6 is able to set a charging voltage at which the operation conditions can be satisfied. Therefore, the storage battery control part 6 is capable of setting a charging voltage for suppressing a deterioration of the storage battery, and it is possible to prolong the lifespan of the storage battery.

In addition, the storage battery control part 6 calculates a predicted capacity by using the digital model 92a capable of reproducing the operation and deterioration characteristics of the storage battery in a simulative manner. Therefore, it is possible to cope with various operation conditions and efficiently calculate a predicted capacity.

Note that the above-described embodiment can be appropriately modified by partially changing the configuration or function of each of the above-described devices. Some modifications of the above-described embodiment will be described below. In the following description, differences of the modifications from the above-described embodiment will be mainly described, and the same points of the modifications as those of the above-described embodiment will be omitted.

(First Modification)

In the storage battery control system 1 of FIG. 1, while the storage battery control part 6 is disposed outside the storage battery system 5, the present invention is not limited thereto. The storage battery control part 6 may be included in the storage battery system 5.

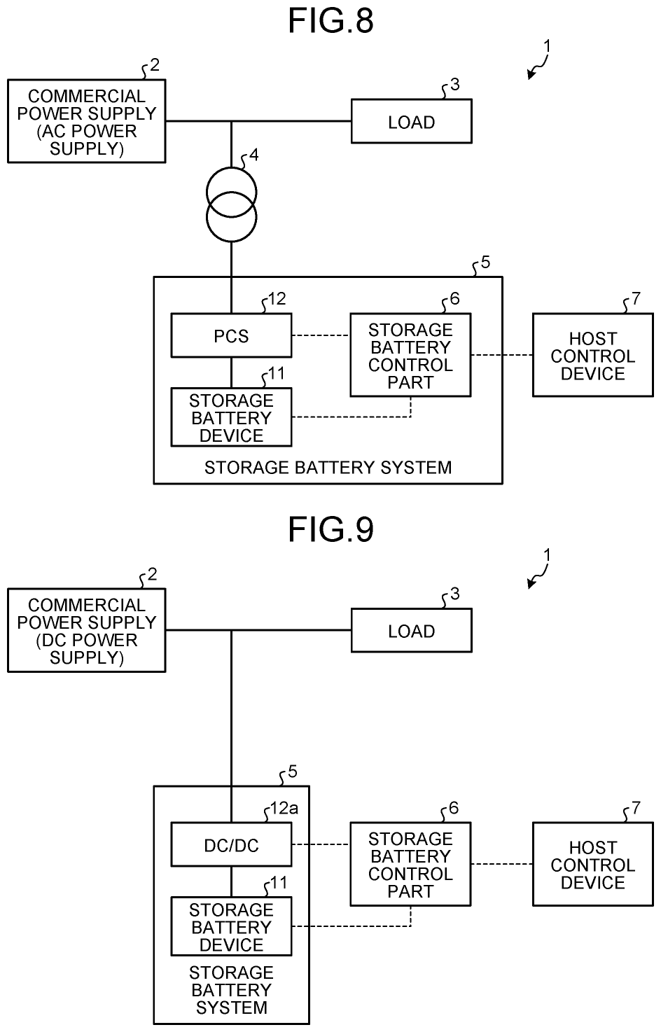

FIG. 8 is a diagram schematically illustrating an example of a configuration of a storage battery control system 1 according to the present modification. As illustrated in FIG. 8, in the storage battery control system 1 according to the present modification, the storage battery control part 6 is provided inside the storage battery system 5. In addition, the storage battery control part 6 is connected to the storage battery device 11 and the PCS 12 in a communicable state. As a result, the storage battery control part 6 can control a charging voltage for charging the storage battery at a constant voltage, and thus, can achieve the same effect as that in the above-described embodiment.

(Second Modification)

In the storage battery control system 1 of FIG. 1, the transformer 4 is disposed outside the storage battery system 5. However, the present invention is not limited thereto, and the transformer 4 may be included in the storage battery system 5. In this case as well, the storage battery control part 6 can control a charging voltage for charging the storage battery at a constant voltage, and thus, can achieve the same effect as that in the above-described embodiment.

(Third Modification)

In the storage battery control system 1 of FIG. 1, while the storage battery system 5 inputs and outputs AC power to and from the commercial power supply 2 and the load 3, the present invention is not limited thereto. In a case where the commercial power supply 2 and the load 3 are capable of transmitting and receiving DC power, the storage battery system 5 may input and output DC power.

In this case, the storage battery control system 1 can have, for example, the configuration of FIG. 9. FIG. 9 is a diagram schematically illustrating an example of a configuration of a storage battery control system 1 according to the present modification.

As illustrated in FIG. 9, the storage battery control system 1 according to the present modification includes a power device 12a such as a DC/DC converter capable of processing DC power instead of the PCS 12. DC power is input and output between the storage battery device 11 and the commercial power supply 2 that is a DC power supply or the load 3 via the power device 12a.

In addition, the storage battery control part 6 controls a charging voltage of the storage battery in cooperation with the power device 12a. As a result, the storage battery control part 6 can control a charging voltage for charging the storage battery at a constant voltage, and thus the same effect as that in the above-described embodiment can be achieved.

### Second Embodiment

Next, a second embodiment will be described. The same reference signs are given to the same components as those in the above-described embodiment, and the description thereof will be appropriately omitted.

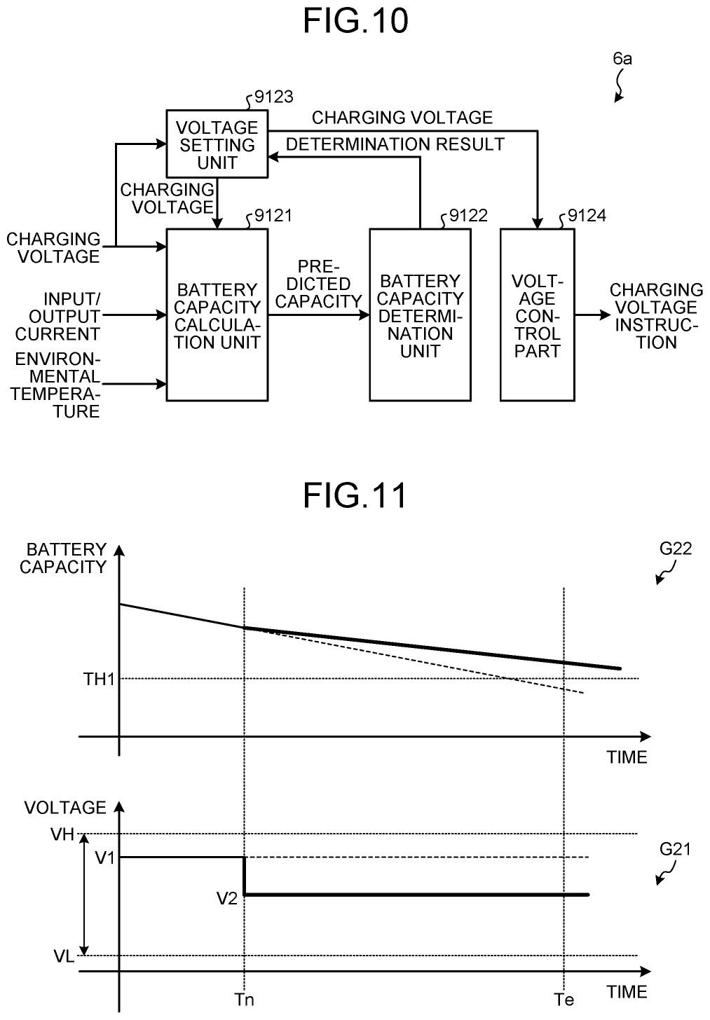

FIG. 10 is a diagram illustrating an example of a functional configuration of a storage battery control part 6a according to the second embodiment. Note that a hardware configuration of the storage battery control part 6a is similar to the above-described configuration of FIG. 4.

As illustrated in FIG. 10, the storage battery control part 6a includes, as functional units, a battery capacity calculation unit 9121, a battery capacity determination unit 9122, a voltage setting unit 9123, and a voltage control part 9124.

The battery capacity calculation unit 9121 is an example of a first calculation unit. The battery capacity calculation unit 9121 has the same function as the battery capacity calculation unit 9111. In addition, the battery capacity calculation unit 9121 performs calculation processing by using a charging voltage changed by the voltage setting unit 9123 to calculate a predicted voltage based on the changed charging voltage.

The battery capacity determination unit 9122 is an example of a first determination unit. On the basis of the calculation result of the battery capacity calculation unit 9121, the battery capacity determination unit 9122 determines whether a predicted capacity in a predetermined period or at a predetermined time point is equal to or greater than a first threshold value, and outputs the determination result to the voltage setting unit 9123. For example, the battery capacity determination unit 9122 determines whether a predicted capacity at the time point of the device-sustainable year is equal to or greater than the first threshold value.

The voltage setting unit 9123 is an example of a first change unit. The voltage setting unit 9123 sets a charging voltage to be used for constant voltage charging on the basis of the determination result of the battery capacity determination unit 9122. Specifically, when the determination result of the battery capacity determination unit 9122 indicates that the predicted capacity is equal to or greater than the first threshold value, the voltage setting unit 9123 sets the charging voltage used in the calculation of the battery capacity calculation unit 9121 as a charging voltage for constant voltage charging.

On the other hand, when the determination result of the battery capacity determination unit 9122 indicates that the predicted capacity is smaller than the first threshold value, the voltage setting unit 9123 virtually changes the charging voltage by decreasing the charging voltage by a predetermined amount. Next, the voltage setting unit 9123 inputs the changed charging voltage to the battery capacity calculation unit 9121, and thereby causes the battery capacity calculation unit 9121 to calculate a predicted capacity on the basis of the changed charging voltage. As a result, the battery capacity determination unit 9122 executes the determination processing again based on the predicted capacity newly calculated by the battery capacity calculation unit 9121, and the determination result is output to the voltage setting unit 9123.

In addition, the voltage setting unit 9123 decreases the charging voltage by a predetermined amount every time the above-described processing is repeatedly executed until the determination result of the battery capacity determination unit 9122 indicates that the predicted capacity becomes equal to or greater than the first threshold value. Then, when the predicted capacity becomes equal to or greater than the first threshold value, the voltage setting unit 9123 sets the voltage value of the charging voltage used in the calculation of the battery capacity calculation unit 9121 as a charging voltage for constant voltage charging.

Note that the voltage setting unit 9123 may be configured to set a voltage value at which the predicted capacity at a predetermined future time point is equal to or greater than the first threshold value at a time on the basis of a tendency toward which the predicted capacity changes, a difference value of the predicted capacity from the first threshold value, and so forth. In this case, for example, the voltage setting unit 9123 may determine a changed charging voltage on the basis of table data associated with a relationship between a difference value from the first threshold value and an amount of change in charging voltage.

The voltage control part 9124 instructs the charging voltage set by the voltage setting unit 9123 to the PCS 12. As a result, when the storage battery is charged at a constant voltage, it is possible to apply a charging voltage at which it is confirmed that the predicted capacity in the predetermined period or at the predetermined time point is equal to or greater than the first threshold value.

FIG. 11 is a diagram schematically illustrating an example of a calculation result of the battery capacity calculation unit 9121. Note that graphs G21 and G22 illustrated in FIG. 11 have the same forms as the graphs G11 and G12 illustrated in FIG. 6, and thus, the description thereof, for example, about each axis, will be omitted.

In FIG. 11, a calculation result corresponds to a case where constant voltage charging is performed at a charging voltage V1 until a time Tn as a current time point. In FIG. 11, a charging voltage V1 and a predicted capacity in a period from the time Tn to the time Te in a case where the charging voltage V1 is continued are indicated by broken lines.

When, for example, the predicted capacity is smaller than a threshold value TH1 in the period from the time Tn to the time Te (or at the time Te), the battery capacity determination unit 9122 outputs, to the voltage setting unit 9123, a determination result representing that the predicted capacity is smaller than the first threshold value. In this case, the voltage setting unit 9123 inputs a charging voltage V2 obtained by decreasing the charging voltage V1 by a predetermined amount to the battery capacity calculation unit 9121 in order to cause the battery capacity calculation unit 9121 to calculate a predicted capacity based on the changed charging voltage V2.

In FIG. 11, the charging voltage V2 and the predicted capacity based on the charging voltage V2 are indicated by solid lines. It is also indicated in FIG. 11 that, in accordance with the change from the charging voltage V1 to the charging voltage V2, the predicted capacity becomes equal to or greater than the threshold value TH1 in the period from the time Tn to the time Te (or at the time Te). Note that the voltage setting unit 9123 changes the charging voltage in the range of voltages VL to VH.

Then, when the voltage setting unit 9123 confirms that the predicted capacity is equal to or greater than the threshold value TH1 on the basis of the determination result of the battery capacity determination unit 9122, the voltage setting unit 9123 sets the charging voltage V2 used in the calculation of the predicted capacity at that time as a voltage for constant voltage charging.

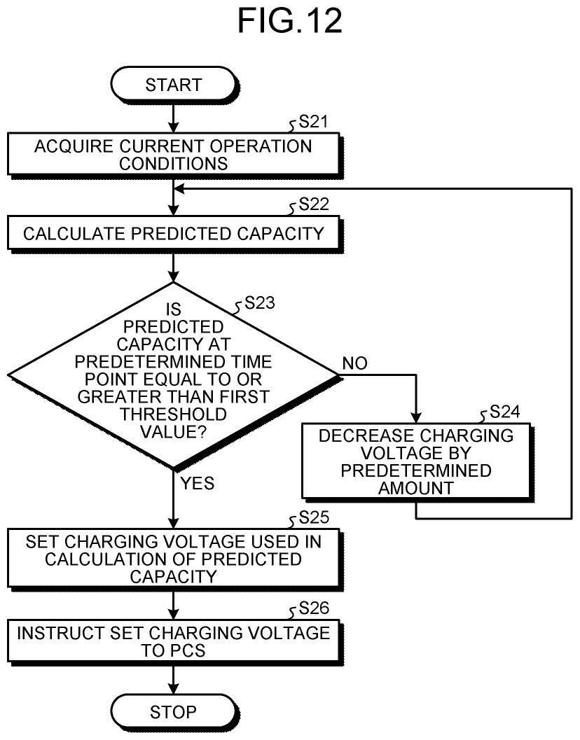

Hereinafter, the operation of the storage battery control part 6a will be described with reference to FIG. 12. FIG. 12 is a flowchart illustrating an example of processing executed by the storage battery control part 6a. Note that the timing at which this processing is executed is not particularly limited, but the present embodiment will be described assuming that this processing is performed at the time of constant voltage charging.

First, the battery capacity calculation unit 9121 acquires current operation conditions of the storage battery (step S21). Next, the battery capacity calculation unit 9121 calculates a predicted capacity of the storage battery in a predetermined period that is future from the present on the basis of the operation conditions acquired in step S21 (step S22).

On the basis of the calculation result of step S22, the battery capacity determination unit 9122 determines whether the predicted capacity at a predetermined time point, such as a device-sustainable year, is equal to or greater than a first threshold value (step S23).

In response to determining in step S23 that the predicted capacity is smaller than the first threshold value (step S23; No), the voltage setting unit 9123 sets a new charging voltage obtained by decreasing the charging voltage by a predetermined amount (step S24). Next, the voltage setting unit 9123 executes the processing of step S22 by using the new charging voltage set in step S24, and thereby causes the battery capacity calculation unit 9121 to calculate a predicted capacity based on the changed charging voltage.

In addition, in response to determining in step S23 that the predicted capacity is equal to or greater than the first threshold value (step S23; Yes), the voltage setting unit 9123 sets the charging voltage used in the calculation processing of step S22 as a charging voltage for constant voltage charging (step S25).

Then, the voltage control part 9124 instructs the charging voltage set in step S25 to the PCS 12 (step S26), and ends this processing.

As described above, when the battery capacity (predicted capacity) of the storage battery in the predetermined period is smaller than the first threshold value, the storage battery control part 6a can specify a charging voltage at which the battery capacity can be equal to or greater than the first threshold value, by virtually changing the charging voltage.

As a result, for example, under the current operation conditions, when the storage battery cannot be used up to the device-sustainable year in a state where the battery capacity is kept equal to or greater than the first threshold value, the storage battery control part 6a can set a charging voltage at which the conditions can be satisfied without actually operating the charging voltage. Therefore, since the storage battery control part 6a is capable of setting a charging voltage for suppressing a deterioration of the storage battery, it is possible to efficiently prolong the lifespan of the storage battery.

Note that the voltage setting unit 9123 automatically sets a charging voltage in the present embodiment, but the present invention is not limited thereto, and the charging voltage may be set on the basis of a user operation via the input unit 93. In this case, for example, after changing the charging voltage one or more times, the voltage setting unit 9123 may cause the display unit 94 to display a screen in which each charging voltage is associated with a predicted capacity corresponding to each charging voltage, and thereby cause a user to select a desired charging voltage. As charging voltages to be displayed, only charging voltages at which predicted capacities are equal to or greater than the first threshold value at the time point of device-sustainable year may be displayed, or charging voltages at which predicted capacities are smaller than the first threshold value may be displayed together therewith.

Note that, when the predicted capacity in the predetermined period (or at the predetermined time point) cannot be made equal to or greater than the first threshold value even if the charging voltage is changed in the range of voltages VL to VH, the voltage setting unit 9123 may suppress the automatic setting of the charging power. In such a case, the voltage setting unit 9123 may cause the display unit 94 to display an alert screen indicating that the charging voltage cannot be set. In addition, the voltage setting unit 9123 may be configured to make notification of the alert for the host control device 7.

In addition, the voltage setting unit 9123 may suppress the operation of changing the charging voltage when the number of times of changing the charging voltage reaches a threshold value. In this case as well, similarly to what is described above, the voltage setting unit 9123 may cause the display unit 94 to display a notification screen indicating that the charging voltage cannot be automatically set. In addition, the voltage setting unit 9123 may be configured to make notification of the alert for the host control device 7.

### Third Embodiment

Next, a third embodiment will be described. The same reference signs are given to the same components as those in the above-described embodiment, and the description thereof will be appropriately omitted.

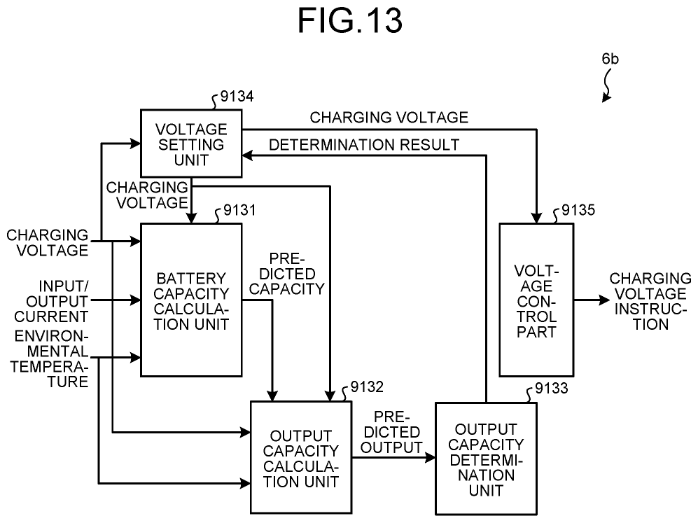

FIG. 13 is a diagram illustrating an example of a functional configuration of a storage battery control part 6b according to the third embodiment. Note that a hardware configuration of the storage battery control part 6b is similar to the above-described configuration of FIG. 4.

As illustrated in FIG. 13, the storage battery control part 6b includes a battery capacity calculation unit 9131, an output capacity calculation unit 9132, an output capacity determination unit 9133, a voltage setting unit 9134, and a voltage control part 9135 as functional units.

The battery capacity calculation unit 9131 is an example of a first calculation unit. The battery capacity calculation unit 9131 has the same function as the battery capacity calculation unit 9111. In addition, the battery capacity calculation unit 9131 performs calculation processing by using a charging voltage changed by the voltage setting unit 9134 to calculate a predicted voltage based on the changed charging voltage.

The output capacity calculation unit 9132 is an example of a second calculation unit. The output capacity calculation unit 9132 calculates an output capacity such as an amount of power (Wh) that can be output by the storage battery as a predicted output, on the basis of the operation conditions of the storage battery and the predicted capacity calculated by the battery capacity calculation unit 9131. Specifically, the output capacity calculation unit 9132 calculates a predicted output from the charging voltage, the environmental temperature, the predicted capacity, and so forth by using the digital model 92a created for deriving the predicted output.

The output capacity determination unit 9133 is an example of a second determination unit. On the basis of the calculation result of the output capacity calculation unit 9132, the output capacity determination unit 9133 determines whether a predicted output in a predetermined period or at a predetermined time point is equal to or greater than a second threshold value, and outputs the determination result to the voltage setting unit 9134. For example, the output capacity determination unit 9133 determines whether a predicted output at the time point of the device-sustainable year is equal to or greater than the second threshold value.

The voltage setting unit 9134 is an example of a second change unit. The voltage setting unit 9134 sets a charging voltage to be used for constant voltage charging on the basis of the determination result of the output capacity determination unit 9133. Specifically, when the determination result of the output capacity determination unit 9133 indicates that the predicted output is equal to or greater than the second threshold value, the voltage setting unit 9134 sets the predicted output as a charging voltage for constant voltage charging.

On the other hand, when the determination result of the output capacity determination unit 9133 indicates that the predicted output is smaller than the second threshold value, the voltage setting unit 9134 virtually changes the charging voltage by increasing the charging voltage by a predetermined amount. Next, the voltage setting unit 9134 inputs the changed charging voltage to the battery capacity calculation unit 9131, and thereby causes the battery capacity calculation unit 9131 to calculate a predicted capacity based on the changed charging voltage. As a result, the output capacity determination unit 9133 executes the determination process again on the basis of the predicted output newly calculated by the output capacity calculation unit 9132, and the determination result is output to the voltage setting unit 9134.

In addition, the voltage setting unit 9134 increases the charging voltage by a predetermined amount every time the above-described processing is repeatedly executed until the determination result of the output capacity determination unit 9133 indicates that the predicted output becomes equal to or greater than the second threshold value. Then, when the predicted output becomes the second threshold value, the voltage setting unit 9134 sets the voltage value of the charging voltage used in the calculation of the battery capacity calculation unit 9131 as a charging voltage for constant voltage charging.

Note that the voltage setting unit 9134 may be configured to set a voltage value at which the predicted output at a predetermined future time point is equal to or greater than the second threshold value at a time on the basis of a tendency toward which the predicted capacity or the predicted output changes, a difference value of the predicted output from the second threshold value, and so forth. In this case, for example, the voltage setting unit 9134 may determine a changed charging voltage on the basis of table data associated with a relationship between a difference value from the second threshold value and an amount of change in charging voltage.

The voltage control part 9135 instructs the charging voltage set by the voltage setting unit 9134 to the PCS 12. As a result, when the storage battery is charged at a constant voltage, it is possible to apply a charging voltage at which it is confirmed that the predicted output in the predetermined period or at the predetermined time point is equal to or greater than the second threshold value.

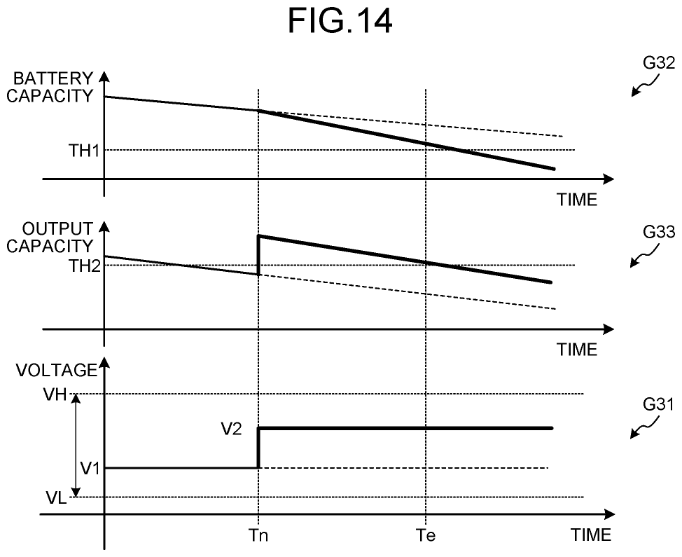

FIG. 14 is a diagram schematically illustrating an example of calculation results of the battery capacity calculation unit 9131 and the output capacity calculation unit 9132. In FIG. 14, graphs G31 and G32 show an example of a calculation result of the battery capacity calculation unit 9131. Note that the graphs G31 and G32 have the same forms as the graphs G11 and G12 illustrated in FIG. 6, and thus, the description thereof, for example, about each axis, will be omitted.

In addition, the graph G33 schematically shows an example of a calculation result of the output capacity calculation unit 9132. The graph G33 shows how the predicted output of the storage battery goes, where the vertical axis represents output capacity (Wh) and the horizontal axis represents time. The threshold value TH2 is an example of a second threshold value, and refers to a minimum value of the required output capacity. Note that the horizontal axes (time axes) of the graphs G31, G32, and G33 are synchronized.

In the example illustrated in FIG. 14, the constant voltage charging of the storage battery is performed at the charging voltage V1 until a time Tn, which denotes a current time point. In FIG. 14, results of calculating a predicted voltage and a predicted output correspond to a case where the constant voltage charging is continued at the same charging voltage in the future. Specifically, in FIG. 14, a charging voltage V1 after the time Tn and a predicted capacity and a predicted output calculated on the basis of the charging voltage V1 are indicated by broken lines.

Here, for example, when the predicted output is smaller than the threshold value TH2 in the period from the time Tn to the time Te (or at the time Te), the output capacity determination unit 9133 outputs a determination result indicating that the predicted output is smaller than the second threshold value to the voltage setting unit 9134. In this case, the voltage setting unit 9134 inputs a charging voltage V2 obtained by increasing the charging voltage V1 by a predetermined amount to the battery capacity calculation unit 9131, and thereby causes the battery capacity calculation unit 9131 and the output capacity calculation unit 9132 to calculate a predicted capacity and a predicted output based on the changed charging voltage V2.

In FIG. 14, the charging voltage V2 and the results of calculating the predicted capacity and the predicted output based on the charging voltage V2 are indicated by solid lines. It is also indicated in FIG. 14 that, in accordance with the change from the charging voltage V1 to the charging voltage V2, the predicted output becomes equal to or greater than the threshold value TH2 in the period from the time Tn to the time Te (or at the time Te). Note that the voltage setting unit 9134 changes the charging voltage in the range of voltages VL to VH.

Then, when it is confirmed that the predicted output is equal to or greater than the threshold value TH2 on the basis of the determination result of the output capacity determination unit 9133, the voltage setting unit 9134 sets the charging voltage V2 used in the calculation of the predicted capacity and the predicted output at that time as a voltage for constant voltage charging.

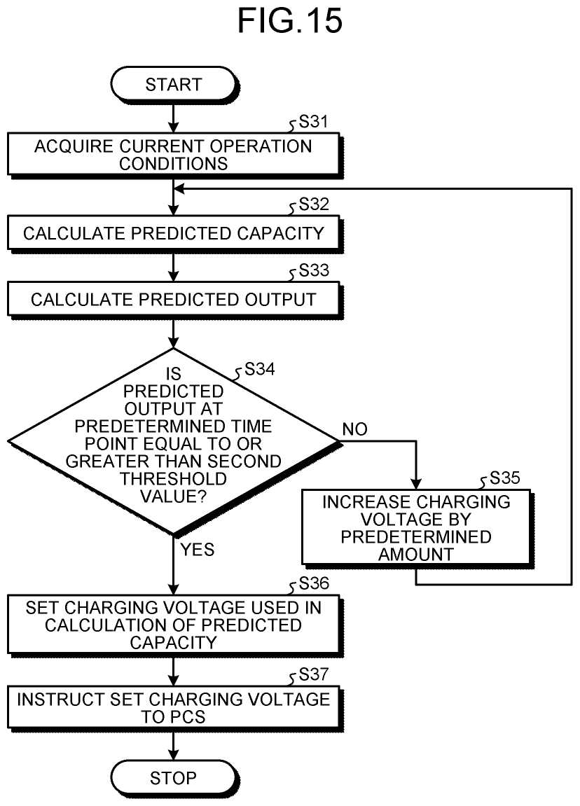

Hereinafter, the operation of the storage battery control part 6b will be described with reference to FIG. 15. FIG. 15 is a flowchart illustrating an example of processing executed by the storage battery control part 6b. Note that the timing at which this processing is executed is not particularly limited, but the present embodiment will be described assuming that this processing is performed at the time of constant voltage charging.

First, the battery capacity calculation unit 9131 acquires current operation conditions of the storage battery (step S31). Next, the battery capacity calculation unit 9131 calculates a predicted capacity of the storage battery in a predetermined period that is future from the present on the basis of the operation conditions acquired in step S31 (step S32).

In addition, the output capacity calculation unit 9132 calculates a predicted output of the storage battery in the predetermined period that is future from the present on the basis of the current operation conditions of the storage battery and the calculation result of step S32 (step S33). Next, on the basis of the calculation result of step S33, the output capacity determination unit 9133 determines whether the predicted output at a predetermined time point, such as a device-sustainable year, is equal to or greater than a second threshold value (step S34).

In response to determining in step S34 that the predicted output is smaller than the second threshold value (step S34; No), the voltage setting unit 9134 sets a new charging voltage obtained by increasing the charging voltage by a predetermined amount (step S35). Next, the voltage setting unit 9134 causes the battery capacity calculation unit 9131 and the output capacity calculation unit 9132 to execute the processing of step S32 by using the new charging voltage set in step S35 in order to calculate a predicted capacity and a predicted output based on the changed charging voltage.

In addition, in response to determining in step S34 that the predicted output is equal to or greater than the second threshold value (step S34; Yes), the voltage setting unit 9134 sets the charging voltage used in the calculation processing of step S32 as a charging voltage for constant voltage charging (step S36).

Then, the voltage control part 9135 instructs the charging voltage set in step S36 to the PCS 12 (step S37), and ends this processing.

As described above, when the output capacity (predicted output) of the storage battery in the predetermined period is smaller than the second threshold value, the storage battery control part 6b can specify a charging voltage at which the output capacity can be equal to or greater than the second threshold value by virtually changing the charging voltage.

As a result, for example, under the current operation conditions, when the storage battery cannot be used up to the device-sustainable year in a state where the output capacity is kept equal to or greater than the second threshold value, the storage battery control part 6b can set a charging voltage at which the conditions can be satisfied without actually operating the charging voltage. Therefore, the storage battery control part 6b can improve the availability of the storage battery.

Note that, even if the charging voltage is changed in the range of voltages VL to VH, when the predicted output in the predetermined period (or at the predetermined time point) cannot be made equal to or greater than the second threshold value, the voltage setting unit 9134 may suppress the automatic setting of the charging power. In addition, even in a case where the predicted output in the predetermined period (or at the predetermined time point) can be equal to or greater than the second threshold value, when the predicted capacity in the predetermined period (or at the predetermined time point) is smaller than the first threshold value, the voltage setting unit 9134 may suppress the automatic setting of the charging power. In such a case, the voltage setting unit 9134 may cause the display unit 94 to display an alert screen indicating that the charging voltage cannot be set. In addition, the voltage setting unit 9134 may be configured to make notification of the alert for the host control device 7.

In addition, the voltage setting unit 9134 may suppress the operation of changing the charging voltage when the number of times of changing the charging voltage reaches a threshold value. In this case as well, similarly to what is described above, the voltage setting unit 9134 may cause the display unit 94 to display a notification screen indicating that the charging voltage cannot be automatically set. In addition, the voltage setting unit 9134 may be configured to make notification of the alert for the host control device 7.

### Fourth Embodiment

Next, a fourth embodiment will be described. The same reference signs are given to the same components as those in the above-described embodiment, and the description thereof will be appropriately omitted.

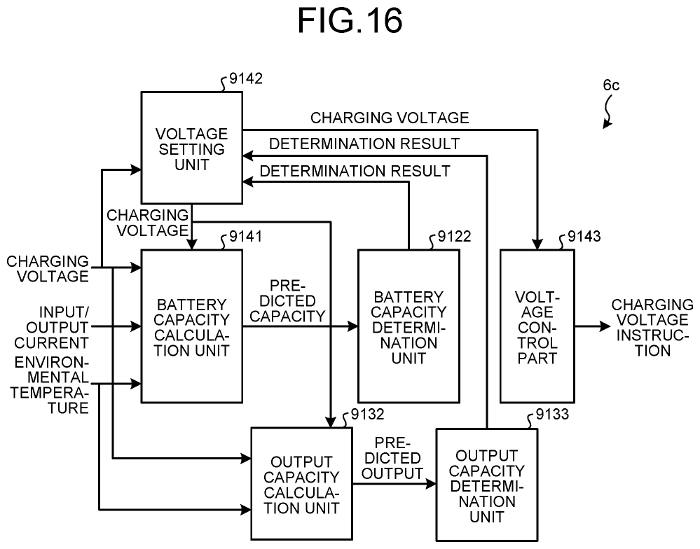

FIG. 16 is a diagram illustrating an example of a functional configuration of a storage battery control part 6c according to the fourth embodiment. Note that a hardware configuration of the storage battery control part 6c is similar to the above-described configuration of FIG. 4.

As illustrated in FIG. 16, the storage battery control part 6c includes a battery capacity calculation unit 9141, a battery capacity determination unit 9122, an output capacity calculation unit 9132, an output capacity determination unit 9133, a voltage setting unit 9142, and a voltage control part 9143 as functional units. The storage battery control part 6c has the functions described in both the second embodiment and the third embodiment.

The battery capacity calculation unit 9141 is an example of a first calculation unit. The battery capacity calculation unit 9141 has the same function as the battery capacity calculation unit 9111. In addition, the battery capacity calculation unit 9141 performs calculation processing by using a charging voltage changed by the voltage setting unit 9142 to calculate a predicted capacity based on the changed charging voltage.

The battery capacity determination unit 9122 is an example of a first determination unit. On the basis of the calculation result of the battery capacity calculation unit 9141, the battery capacity determination unit 9122 determines whether a predicted capacity in a predetermined period or at a predetermined time point is equal to or greater than a first threshold value, and outputs the determination result to the voltage setting unit 9142.

The output capacity calculation unit 9132 is an example of a second calculation unit. The output capacity calculation unit 9132 calculates an output capacity that can be output by the storage battery as a predicted output, on the basis of the operation conditions of the storage battery and the predicted capacity calculated by the battery capacity calculation unit 9141.

The output capacity determination unit 9133 is an example of a second determination unit. On the basis of the calculation result of the output capacity calculation unit 9132, the output capacity determination unit 9133 determines whether a predicted output in a predetermined period or at a predetermined time point is equal to or greater than a second threshold value, and outputs the determination result to the voltage setting unit 9142.

The voltage setting unit 9142 is an example of a first change unit and a second change unit. The voltage setting unit 9142 sets a charging voltage to be used for constant voltage charging on the basis of the determination results of the battery capacity determination unit 9122 and the output capacity determination unit 9133.

Specifically, when the determination result of the battery capacity determination unit 9122 indicates that the predicted capacity is smaller than the first threshold value, the voltage setting unit 9142 virtually changes the charging voltage by decreasing the charging voltage by a predetermined amount. In addition, when the determination result of the output capacity calculation unit 9132 indicates that the predicted output is smaller than the second threshold value, the voltage setting unit 9142 virtually changes the charging voltage by increasing the charging voltage by a predetermined amount. Then, the voltage setting unit 9142 inputs the changed charging voltage to the battery capacity calculation unit 9141, and thereby causes the battery capacity calculation unit 9141 and the output capacity calculation unit 9132 to calculate a predicted capacity and a predicted output based on the changed charging voltage.

In addition, when the determination result of the battery capacity determination unit 9122 indicates that the predicted capacity is equal to or greater than the first threshold value and the determination result of the output capacity calculation unit 9132 indicates that the predicted output is equal to or greater than the second threshold value, the voltage setting unit 9142 sets the charging voltage used in the calculation of the battery capacity calculation unit 9141 as a charging voltage for constant voltage charging.

Note that, when the determination result of the battery capacity determination unit 9122 indicates that the predicted capacity is smaller than the first threshold value and the determination result of the output capacity calculation unit 9132 indicates that the predicted output is smaller than the second threshold value, the voltage setting unit 9142 changes the charging voltage from an item of which a predetermined priority is high (the battery capacity or the possible output capacity).

The voltage control part 9143 instructs the charging voltage set by the voltage setting unit 9142 to the PCS 12. As a result, when the storage battery is charged at a constant voltage, it is possible to apply a charging voltage at which it is confirmed that the predicted capacity is equal to or greater than the first threshold value and the predicted output is equal to or greater than the second threshold value in the predetermined period or at the predetermined time point.

As described above, the storage battery control part 6c has the functions described in the second embodiment and the third embodiment. Therefore, the storage battery control part 6c can set a charging voltage at which both a predicted capacity and a predicted output of the storage battery satisfy the predetermined conditions as a charging voltage for constant voltage charging.

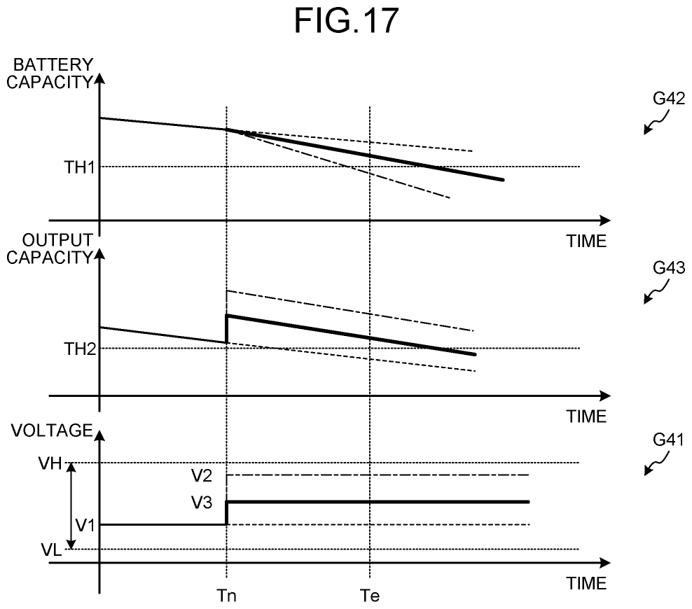

FIG. 17 is a diagram schematically illustrating an example of calculation results of the battery capacity calculation unit 9141 and the output capacity calculation unit 9132. In FIG. 17, graphs G41 and G42 show an example of a calculation result of the battery capacity calculation unit 9141. A graph G43 shows an example of a calculation result of the output capacity calculation unit 9132. Note that the graphs G41, G42, and G43 have the same forms as the graphs G31, G32, and G33 described in the third embodiment, and thus, the description thereof, for example, about each axis, will be omitted.

In the example illustrated in FIG. 17, the constant voltage charging of the storage battery is performed at a charging voltage V1 until a time Tn as a current time point. In FIG. 17, results of calculating a predicted voltage and a predicted output correspond to a case where the constant voltage charging is continued at the same charging voltage in the future are illustrated. Specifically, a charging voltage V1 after the time Tn and a predicted capacity and a predicted output calculated on the basis of the charging voltage V1 are indicated by broken lines.

Here, for example, when the predicted output is smaller than the threshold value TH2 in the period from the time Tn to the time Te (or at the time Te), the output capacity determination unit 9133 outputs a determination result indicating that the predicted output is smaller than the threshold value TH2 to the voltage setting unit 9142. In this case, the voltage setting unit 9142 inputs a charging voltage V2 obtained by increasing the charging voltage V1 by a predetermined amount to the battery capacity calculation unit 9141, and thereby causes the battery capacity calculation unit 9141 and the output capacity calculation unit 9132 to calculate a predicted capacity and a predicted output based on the changed charging voltage V2.

In FIG. 17, a charging voltage V2 and a predicted capacity and a predicted output calculated on the basis of the charging voltage V2 are indicated by alternate long and short dash lines. It is also indicated in FIG. 17 that, in accordance with the change from the charging voltage V1 to the charging voltage V2, the predicted output becomes equal to or greater than the threshold value TH2 in the period from the time Tn to the time Te (or at the time Te).

It is also indicated in FIG. 17 that, in accordance with the change to the charging voltage V2, the predicted capacity becomes smaller than the threshold value TH1 in the period from the time Tn to the time Te (or at the time Te). In this case, the battery capacity determination unit 9122 outputs a determination result indicating that the predicted capacity is smaller than the threshold value TH1 to the voltage setting unit 9142. In this case, the voltage setting unit 9142 inputs a charging voltage V3 obtained by increasing the charging voltage V2 by a predetermined amount to the battery capacity calculation unit 9141, and thereby causes the battery capacity calculation unit 9141 and the output capacity calculation unit 9132 to calculate a predicted capacity and a predicted output based on the changed charging voltage V3. Note that, in FIG. 17, a changed charging voltage V3 and a predicted capacity and a predicted output calculated on the basis of the charging voltage V3 are indicated by solid lines.

Note that the voltage setting unit 9134 changes the charging voltage within the range of voltages VL to VH. In addition, the increased amount and the decreased amount of the charging voltage may be the same amount, but in a case where changing operations having different increasing and decreasing directions are consecutively performed, it is preferable to make different an amount in which the charging voltage is changeable at a time. For example, the voltage setting unit 9142 may change a magnitude of a next change in accordance with the magnitude or the increasing/decreasing direction of the change in charging voltage performed immediately before. As an example, when the increasing/decreasing direction of the charging voltage changed last time is different from the increasing/decreasing direction of the charging voltage changed this time, the amount of change this time is preferably smaller than the amount of change last time.

Then, when it is confirmed that the predicted capacity is equal to or greater than the first threshold value and the predicted output is equal to or greater than the second threshold value, for example, at the time Te, in accordance with the change to the charging voltage V3, the voltage setting unit 9142 sets the charging voltage V3 at that time as a charging voltage for constant voltage charging.

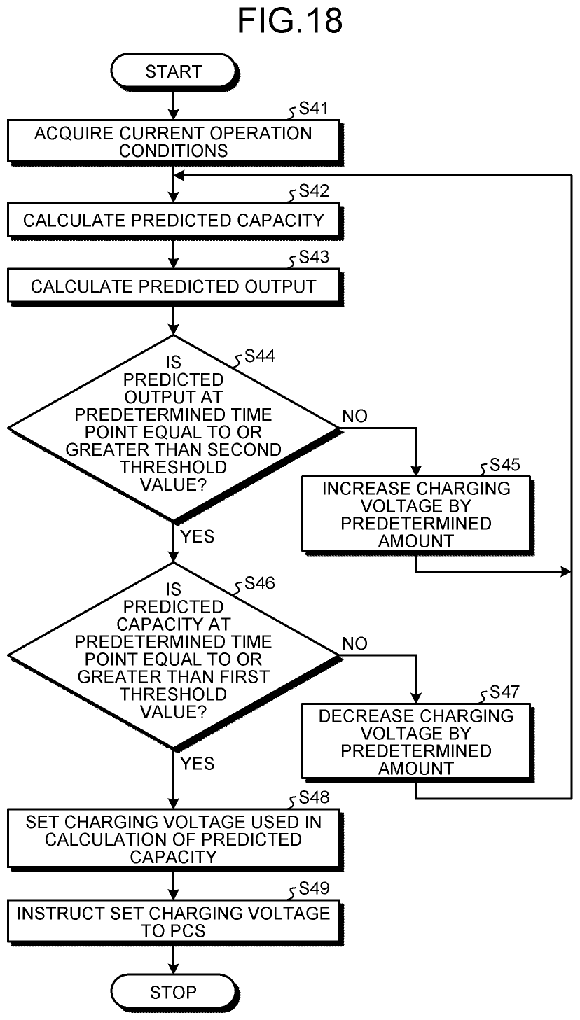

Hereinafter, the operation of the storage battery control part 6c will be described with reference to FIG. 18. FIG. 18 is a flowchart illustrating an example of processing executed by the storage battery control part 6c. Note that the timing at which this processing is executed is not particularly limited, but the present embodiment will be described assuming that this processing is performed at the time of constant voltage charging.

First, the battery capacity calculation unit 9141 acquires current operation conditions of the storage battery (step S41). Next, the battery capacity calculation unit 9141 calculates a predicted capacity of the storage battery in a predetermined period that is future from the present on the basis of the operation conditions acquired in step S41 (step S42). In addition, the output capacity calculation unit 9132 calculates a predicted output of the storage battery in the predetermined period that is future from the present on the basis of the current operation conditions of the storage battery and the calculation result of step S42 (step S43).

Subsequently, on the basis of the calculation result of step S43, the output capacity determination unit 9133 determines whether the predicted output at a predetermined time point, such as a device-sustainable year, is equal to or greater than a second threshold value (step S44).

In response to determining in step S44 that the predicted output is smaller than the second threshold value (step S44; No), the voltage setting unit 9142 sets a new charging voltage obtained by increasing the charging voltage by a predetermined amount (step S45). Next, the voltage setting unit 9142 causes the battery capacity calculation unit 9141 and the output capacity calculation unit 9132 to execute the processing of step S42 by using the new charging voltage set in step S45 in order to calculate a predicted capacity and a predicted output based on the changed charging voltage.

In addition, in response to determining in step S44 that the predicted output is equal to or greater than the second threshold value (step S44; Yes), the battery capacity determination unit 9122 determines whether the predicted capacity at a predetermined time point, such as a device-sustainable year, is equal to or greater than a first threshold value on the basis of the calculation result of step S42 (step S46).

In response to determining in step S45 that the predicted capacity is smaller than the first threshold value (step S46; No), the voltage setting unit 9142 sets a new charging voltage obtained by decreasing the charging voltage by a predetermined amount (step S47). Next, the voltage setting unit 9142 causes the battery capacity calculation unit 9141 and the output capacity calculation unit 9132 to execute the processing of step S42 by using the new charging voltage set in step S47 in order to calculate a predicted capacity and a predicted output based on the changed charging voltage.

In addition, in response to determining in step S46 that the predicted capacity is equal to or greater than the first threshold value (step S46; Yes), the voltage setting unit 9142 sets the charging voltage used in the most recent calculation processing of step S42 as a charging voltage for constant voltage charging (step S48).

Then, the voltage control part 9143 instructs the charging voltage set in step S48 to the PCS 12 (step S49), and ends this processing.

As described above, when the battery capacity (predicted capacity) and the output capacity (predicted output) of the storage battery in the predetermined period do not satisfy the predetermined conditions, the storage battery control part 6c can specify a charging voltage at which the conditions can be satisfied by virtually changing the charging voltage.

As a result, for example, under the current operation conditions, when the storage battery cannot be used up to the device-sustainable year in a state where the battery capacity is kept equal to or greater than the first threshold value and the output capacity is kept equal to or greater than the second threshold value, the storage battery control part 6c can set a charging voltage at which the conditions can be satisfied without actually operating the charging voltage. Therefore, the storage battery control part 6c can prolong the lifespan of the storage battery and improve the availability of the storage battery.

Note that, even if the charging voltage is changed in the range of voltages VL to VH, when the predicted capacity at the time point of the device-sustainable year cannot be made equal to or greater than the first threshold value and the predicted output at the time point of the device-sustainable year cannot be made equal to or greater than the second threshold value, the voltage setting unit 9142 may suppress the automatic setting of the charging power. In such a case, the voltage setting unit 9142 may cause the display unit 94 to display a notification screen indicating that the charging voltage cannot be automatically set. In addition, the voltage setting unit 9142 may be configured to make notification of the alert for the host control device 7.

In addition, the voltage setting unit 9142 may suppress the operation of changing the charging voltage when the number of times of changing the charging voltage reaches a threshold value. In this case as well, similarly to what is described above, the voltage setting unit 9142 may cause the display unit 94 to display a notification screen indicating that the charging voltage cannot be automatically set. In addition, the voltage setting unit 9134 may be configured to make notification of the alert for the host control device 7.

### Fifth Embodiment

Next, a fifth embodiment will be described. The same reference signs are given to the same components as those in the above-described embodiment, and the description thereof will be appropriately omitted.

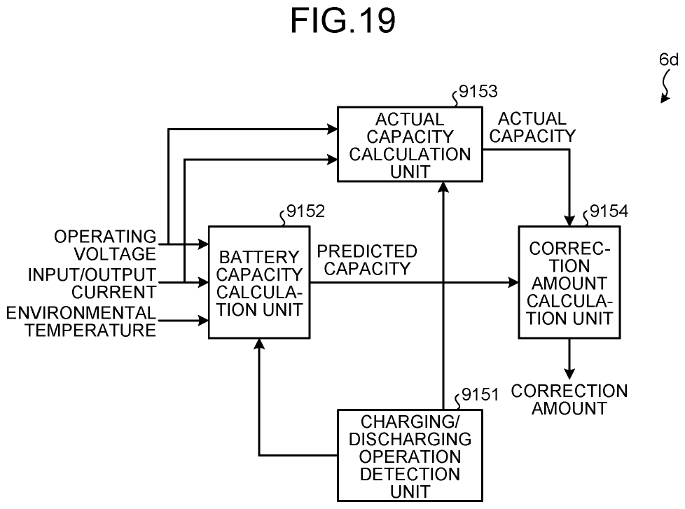

FIG. 19 is a diagram illustrating an example of a functional configuration of a storage battery control part 6d according to the fifth embodiment. Note that a hardware configuration of the storage battery control part 6d is similar to the above-described configuration of FIG. 4.

As illustrated in FIG. 19, the storage battery control part 6d includes charging/discharging operation detection unit 9151, a battery capacity calculation unit 9152, an actual capacity calculation unit 9153, and a correction amount calculation unit 9154 as functional units. Note that, although not illustrated, the storage battery control part 6d has the functional configuration of any one of the above-described embodiments.

The charging/discharging operation detection unit 9151 is an example of a detection unit. The charging/discharging operation detection unit 9151 detects charging/discharging operation of the storage battery system 5. For example, the charging/discharging operation detection unit 9151 detects that the charging/discharging operation of the storage battery system 5 has occurred in cooperation with the PCS 12.

The battery capacity calculation unit 9152 is an example of a third calculation unit. When the charging/discharging operation is detected by the charging/discharging operation detection unit 9151, the battery capacity calculation unit 9152 acquires operation conditions at that time from the storage battery system 5, and calculates a predicted capacity of the storage battery at a current time point on the basis of the acquired operation conditions. In FIG. 19, a voltage applied to the storage battery at the time of detecting the charging/discharging operation, which is acquired as an operation condition by the battery capacity calculation unit 9152, is referred to as an operating voltage.

Note that the function of the actual capacity calculation unit 9153 may be performed by any of the battery capacity calculation units 9111, 9121, 9131, and 9141 of the above-described embodiments. Hereinafter, the battery capacity calculation units 9111, 9121, 9131, and 9141 will be collectively referred to as a main battery capacity calculation unit.

The actual capacity calculation unit 9153 is an example of a first measurement unit. When the charging/discharging operation is detected by the charging/discharging operation detection unit 9151, the actual capacity calculation unit 9153 calculates (measures) an actual battery capacity (hereinafter, also referred to as actual capacity) of the storage battery on the basis of the operation conditions at that time. Specifically, the actual capacity calculation unit 9153 calculates an actual capacity of the storage battery on the basis of an operating voltage, an input/output current, and so forth included in the operation conditions. Note that, as a method of calculating an actual capacity, a known technique can be used.

The correction amount calculation unit 9154 is an example of a first correction unit. The correction amount calculation unit 9154 corrects a setting related to the operation of the main battery capacity calculation unit on the basis of a difference between the predicted capacity calculated by the battery capacity calculation unit 9152 and the actual capacity calculated by the actual capacity calculation unit 9153.

Specifically, the correction amount calculation unit 9154 compares the predicted capacity with the actual capacity, and calculates a correction amount for reducing a difference between the predicted capacity and the actual capacity when the difference becomes equal to or greater than a threshold value. Then, the correction amount calculation unit 9154 corrects the parameter related to the operation of the main battery capacity calculation unit and the digital model 92a on the basis of the calculated correction amount.

Note that the charging/discharging operation of the storage battery system 5 may be dynamically performed in accordance with a situation of the load 3 or the like, or may be periodically performed in accordance with a predetermined schedule. For example, in a case where the charging/discharging operation of the storage battery system 5 is periodically performed in accordance with a predetermined schedule, the charging/discharging operation detection unit 9151 may control the charging/discharging operation of the storage battery system 5 in accordance with the predetermined schedule in cooperation with the PCS 12.

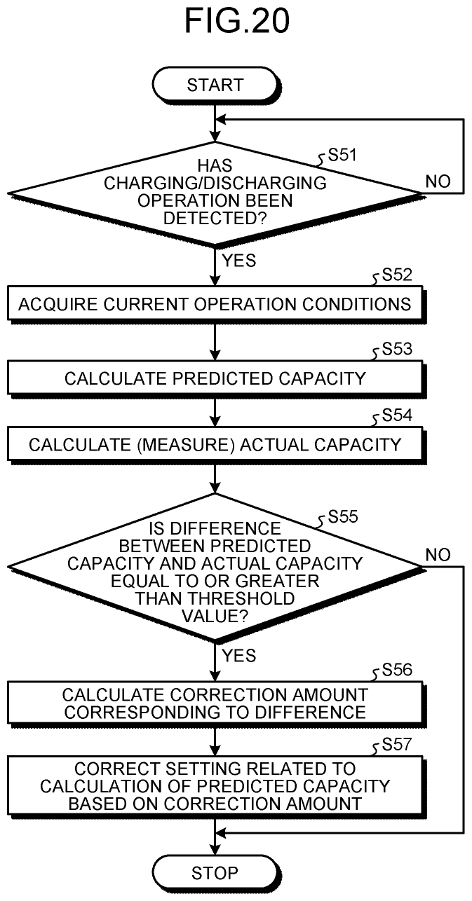

Hereinafter, the operation of the storage battery control part 6d will be described with reference to FIG. 20. FIG. 20 is a flowchart illustrating an example of processing executed by the storage battery control part 6d.

First, the charging/discharging operation detection unit 9151 stands by until charging/discharging operation of the storage battery system 5 is detected (step S51; No). When charging/discharging operation has been detected in step S51 (step S51; Yes), the battery capacity calculation unit 9152 acquires current operation conditions (step S52).

Subsequently, the battery capacity calculation unit 9152 calculates a predicted capacity of the storage battery at a current time point on the basis of the operation conditions acquired in step S52 (step S53). In addition, the actual capacity calculation unit 9153 calculates (measures) an actual capacity of the storage battery at the current time point on the basis of the current operation conditions (step S54).

Subsequently, the correction amount calculation unit 9154 compares the predicted capacity calculated in step S53 with the actual capacity calculated in step S54, and determines whether a difference between the predicted capacity and the actual capacity is equal to or greater than a threshold value (step S55). Here, when the difference between the predicted capacity and the actual capacity is smaller than the threshold value (step S55; No), this processing ends.

On the other hand, in response to determining that the difference between the predicted capacity and the actual capacity is equal to or greater than the threshold value (step S55; Yes), the correction amount calculation unit 9154 calculates a correction amount corresponding to the difference between the predicted capacity and the actual capacity (step S56). Then, the correction amount calculation unit 9154 corrects a setting related to the calculation of the predicted capacity of the main battery capacity calculation unit on the basis of the calculated correction amount (step S57), and ends this processing.

As described above, the storage battery control part 6d acquires a predicted capacity and an actual capacity of the storage battery at a timing when charging/discharging operation is started, and corrects a setting related to the calculation of the predicted capacity of the main battery capacity calculation unit on the basis of a difference between the predicted capacity and the actual capacity.

As a result, the storage battery control part 6d can improve the accuracy of the predicted capacity calculated by the main battery capacity calculation unit, so that a charging voltage can be calculated and controlled more accurately.

### Sixth Embodiment

Next, a sixth embodiment will be described. The same reference signs are given to the same components as those in the above-described embodiment, and the description thereof will be appropriately omitted.

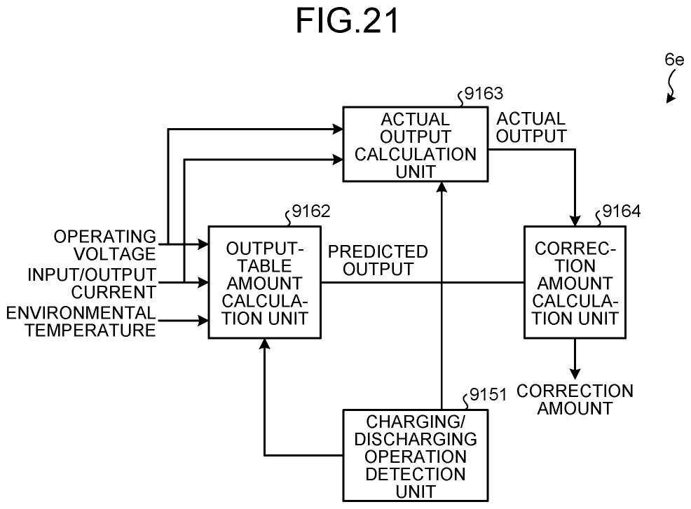

FIG. 21 is a diagram illustrating an example of a functional configuration of a storage battery control part 6e according to the sixth embodiment. Note that a hardware configuration of the storage battery control part 6e is similar to the above-described configuration of FIG. 4.

As illustrated in FIG. 21, the storage battery control part 6e includes charging/discharging operation detection unit 9151, an output capacity calculation unit 9162, an actual output calculation unit 9163, and a correction amount calculation unit 9164 as functional units. Note that, although not illustrated, the storage battery control part 6e has the functional configuration of any of the third and fourth embodiments described above.

The output capacity calculation unit 9162 is an example of a fourth calculation unit. When the charging/discharging operation is detected by the charging/discharging operation detection unit 9151, the output capacity calculation unit 9162 acquires operation conditions at that time from the storage battery system 5, and calculates a predicted output of the storage battery at a current time point on the basis of the acquired operation conditions. Note that the function of the output capacity calculation unit 9162 may be performed by the output capacity calculation unit 9132 of the third or fourth embodiment described above.

The actual output calculation unit 9163 is an example of a second measurement unit. When the charging/discharging operation is detected by the charging/discharging operation detection unit 9151, the actual output calculation unit 9163 calculates (measures) an actual output capacity (hereinafter, also referred to as actual capacity) of the storage battery on the basis of the operation conditions at that time. Specifically, the actual output calculation unit 9163 calculates an actual output of the storage battery on the basis of an operating voltage, an input/output current, and so forth included in the operation conditions. Note that, as a method of calculating an actual output, a known technique can be used.

The correction amount calculation unit 9164 is an example of a second correction unit. The correction amount calculation unit 9164 corrects a setting related to the operation of the output capacity calculation unit 9132 on the basis of a difference between the predicted output calculated by the output capacity calculation unit 9162 and the actual output calculated by the actual output calculation unit 9163.

Specifically, the correction amount calculation unit 9164 compares the predicted output with the actual output, and calculates a correction amount for reducing a difference between the predicted output and the actual output when the difference becomes equal to or greater than a threshold value. Then, the correction amount calculation unit 9164 corrects the parameter related to the operation of the output capacity calculation unit 9132 and the digital model 92a on the basis of the calculated correction amount. As a result, the accuracy of the predicted output calculated by the output capacity calculation unit 9132 can be improved, so that a charging voltage of the storage battery can be more accurately controlled.

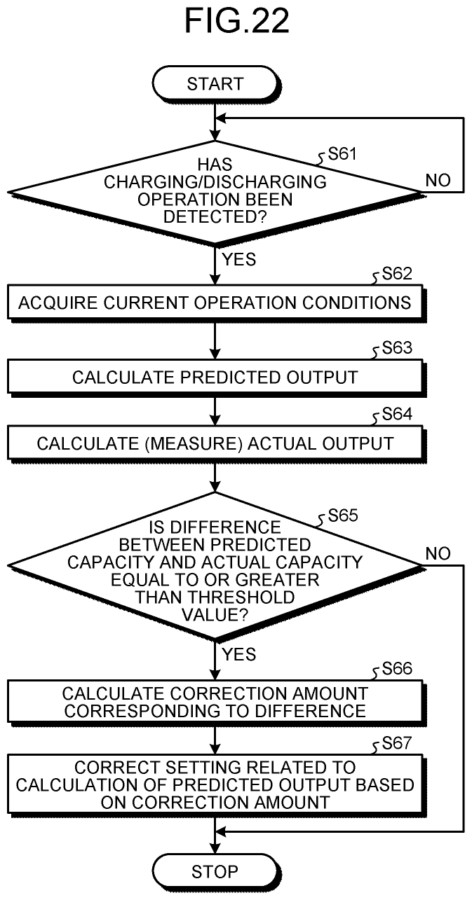

Hereinafter, the operation of the storage battery control part 6e will be described with reference to FIG. 22. FIG. 22 is a flowchart illustrating an example of processing executed by the storage battery control part 6e.

First, the charging/discharging operation detection unit 9151 stands by until charging/discharging operation of the storage battery system 5 is detected (step S61; No). When charging/discharging operation has been detected in step S61 (step S61; Yes), the output capacity calculation unit 9162 acquires current operation conditions (step S62).

Subsequently, the output capacity calculation unit 9162 calculates a predicted output of the storage battery at a current time point on the basis of the operation conditions acquired in step S62 (step S63). In addition, the actual output calculation unit 9163 calculates (measures) an actual output of the storage battery at the current time point on the basis of the current operation conditions (step S64).

Subsequently, the correction amount calculation unit 9164 compares the predicted output calculated in step S63 with the actual output calculated in step S64, and determines whether a difference between the predicted output and the actual output is equal to or greater than a threshold value (step S65). Here, when the difference between the predicted output and the actual output is smaller than the threshold value (step S65; No), this processing ends.

On the other hand, in response to determining that the difference between the predicted output and the actual output is equal to or greater than the threshold value (step S65; Yes), the correction amount calculation unit 9164 calculates a correction amount corresponding to the difference between the predicted output and the actual output (step S66). Then, the correction amount calculation unit 9164 corrects a setting related to the calculation of the predicted output of the output capacity calculation unit 9132 on the basis of the calculated correction amount (step S67), and ends this processing.

As described above, the storage battery control part 6e acquires a predicted output and an actual output of the storage battery at a timing when charging/discharging operation is started, and corrects a setting related to the calculation of the predicted output of the output capacity calculation unit 9132 on the basis of a difference between the predicted output and the actual output.

As a result, the storage battery control part 6e can improve the accuracy of the predicted output calculated by the output capacity calculation unit 9132, so that a charging voltage can be calculated and controlled more accurately.

Although some embodiments of the present invention have been described above, the above-described embodiments and modifications thereof are merely examples, and are not intended to limit the scope of the invention. The above-described embodiments can be implemented in various forms, and various omissions, substitutions, and changes can be made to the above-described embodiments without departing from the gist of the invention. The above-described embodiments and modifications thereof fall within the scope and spirit of the invention, and fall within the scope of the invention set forth in the claims and the equivalent thereof.

### REFERENCE SIGNS LIST

1 STORAGE BATTERY CONTROL SYSTEM
2 COMMERCIAL POWER SUPPLY
3 LOAD
4 TRANSFORMER
5 STORAGE BATTERY SYSTEM
6, 6a, 6b, 6c, 6d, 6e STORAGE BATTERY CONTROL PART
7 HOST CONTROL DEVICE
11 STORAGE BATTERY DEVICE
12 PCS
9111, 9121, 9131, 9141, 9152 BATTERY CAPACITY CALCULATION UNIT
9112, 9124, 9135, 9143 VOLTAGE CONTROL PART
9122 BATTERY CAPACITY DETERMINATION UNIT
9123, 9134, 9142 VOLTAGE SETTING UNIT
9132, 9162 OUTPUT CAPACITY CALCULATION UNIT
9133 OUTPUT CAPACITY DETERMINATION UNIT
9151 CHARGING/DISCHARGING OPERATION DETECTION UNIT
9153 ACTUAL CAPACITY CALCULATION UNIT
9154, 9164 CORRECTION AMOUNT CALCULATION UNIT
9163 ACTUAL OUTPUT CALCULATION UNIT

1. A storage battery control device comprising a hardware processor connected to a memory, the hardware processor being configured to function as:
an acquisition unit to acquire operation conditions of a storage battery system including a storage battery being chargeable and dischargeable;
a first calculation unit to calculate, as a first predicted value, a battery capacity of the storage battery in a predetermined period on the basis of the operation conditions acquired by the acquisition unit, the battery capacity corresponding to a case where the storage battery is operated under the operation conditions; and
a control part to control a charging voltage when the storage battery system charges the storage battery, the charging voltage being controlled on the basis of the first predicted value calculated by the first calculation unit.

2. The storage battery control device according to claim 1, wherein the acquisition unit acquires, as the operation conditions, a charging voltage, an input/output current of the storage battery, and a temperature of the storage battery or a temperature around the storage battery.

3. The storage battery control device according to claim 1, wherein the acquisition unit acquires the first predicted value calculated by the first calculation unit as one of the operation conditions.

4. The storage battery control device according to claim 1, wherein the first calculation unit calculates, by using a digital model, the first predicted value corresponding to the case where the storage battery is operated under the operation conditions, the digital model being capable of reproducing operation and deterioration characteristics of the storage battery in a simulative manner.

5. The storage battery control device according to claim 2, wherein the hardware processor is configured to further function as:
a first determination unit to determine whether the battery capacity of the storage battery in the predetermined period is equal to or greater than a threshold value, on the basis of the first predicted value calculated by the first calculation unit; and
a first change unit to, when the first determination unit makes determination of being smaller than the threshold value, change the charging voltage included in the operation conditions acquired by the acquisition unit and cause the first calculation unit to calculate again a first predicted value, and
wherein, when the first determination unit makes determination of being equal to or greater than the threshold value, the control part causes the storage battery system to charge the storage battery at the charging voltage used in the calculation of the first predicted value.

6. The storage battery control device according to claim 5, wherein the first change unit repeatedly changes the charging voltage until the first determination unit makes the determination of being equal to or greater than the threshold value.

7. The storage battery control device according to claim 5, wherein the first determination unit determines whether a battery capacity of the storage battery at a specific time point included in the predetermined period is equal to or greater than the threshold value.

8. The storage battery control device according to claim 6, wherein, when the number of times of changing the charging voltage exceeds a threshold value, the first change unit suppresses the change of the charging voltage and makes notification of an alert.

9. The storage battery control device according to claim 2, wherein the hardware processor is configured to further function as:
a second calculation unit to calculate, as a second predicted value, a possible output power amount of the storage battery in the predetermined period on the basis of the operation conditions acquired by the acquisition unit, the possible output power amount corresponding to a case where the storage battery is operated under the operation conditions;
a second determination unit to determine whether the possible output power amount of the storage battery in the predetermined period is equal to or greater than a threshold value, on the basis of the second predicted value calculated by the second calculation unit; and
a second change unit to, when the second determination unit makes determination of being smaller than the threshold value, change the charging voltage included in the operation conditions acquired by the acquisition unit and cause the second calculation unit to calculate again a second predicted value, and
wherein, when the second determination unit makes determination of being equal to or greater than the threshold value, the control part causes the storage battery system to charge the storage battery at the charging voltage used in the calculation of the second predicted value.

10. The storage battery control device according to claim 9, wherein the second change unit repeatedly changes the charging voltage until the second determination unit makes determination of being equal to or greater than the threshold value.

11. The storage battery control device according to claim 9, wherein the second determination unit determines whether an possible output power amount of the storage battery at a specific time point included in the predetermined period is equal to or greater than the threshold value.

12. The storage battery control device according to claim 10, wherein, when the number of times of changing the charging voltage exceeds a threshold value, the second change unit suppresses the change of the charging voltage and makes notification of an alert.

13. The storage battery control device according to claim 1, wherein the hardware processor is configured to further function as:
a detection unit to detect charging/discharging operation of the storage battery system;
a third calculation unit to calculate, as a third predicted value, a battery capacity of the storage battery when the charging/discharging operation is detected by the detection unit, the battery capacity being calculated on the basis of the operation conditions of the storage battery system at the time when the charging/discharging operation is detected;
a first measurement unit to measure a battery capacity of the storage battery as an actual measurement value when the charging/discharging operation is detected by the detection unit; and
a first correction unit to correct a setting related to operation of the first calculation unit on the basis of a difference between the third predicted value and the actual measurement value.

14. The storage battery control device according to claim 9, wherein the hardware processor is configured to further function as:
a detection unit to detect charging/discharging operation of the storage battery system;
a fourth calculation unit to calculate, as a fourth predicted value, an possible output power amount of the storage battery when the charging/discharging operation is detected by the detection unit, the possible output power amount being calculated on the basis of the operation conditions of the storage battery system at the time when the charging/discharging operation is detected;
a second measurement unit to measure, as an actual measurement value, an amount of power output from the storage battery in the charging/discharging operation when the charging/discharging operation is detected by the detection unit; and
a second correction unit to correct a setting related to operation of the second calculation unit on the basis of a difference between the fourth predicted value and the actual measurement value.

15. A storage battery control method comprising:
acquiring operation conditions of a storage battery system including a storage battery being chargeable and dischargeable;
calculating, as a first predicted value, a battery capacity of the storage battery in a predetermined period on the basis of the operation conditions acquired by the acquiring, the battery capacity corresponding to a case where the storage battery is operated under the operation conditions; and
controlling a charging voltage when the storage battery system charges the storage battery, the charging voltage being controlled on the basis of the first predicted value calculated by the calculating.
